(19) United States
(12) Patent Application Publication
(10) Pub. No.: US 2005/0191404 A1
(43) Pub. Date: Sep. 1, 2005

(54) Process for manufacture of granular sugar ingredient for compressed confections having improved strength

(76) Inventors: Sigismondo A. DeTora, Pearl River, NY (US); Candice Emerick, Hamilton, MI (US); Pankaj N. Patel, Brandchburg, NJ (US); Andrew Metropole, North Brunswick, NJ (US); John Henshaw, Mendham, NJ (US); Cosjun Pabua, Staten Island, NY (US); Wayne Ramnarine, Bethlehem, PA (US); Joseph W. Bell, Bethlehem, PA (US); Srinivas Vangeepuran, Kendall Park, NJ (US)

Correspondence Address: THADDIUS J. CARVIS, 102 NORTH KING STREET, LEESBURG, VA, 20176, US

(21) Appl. No.: 10/716,581

(22) Filed: Nov. 19, 2003

(51) Int. Cl. A23G 3/00

(52) U.S. Cl. 426/658

(57) ABSTRACT

A method provides a dry granular sugar ingredient, which improves the production of compressed, tableted confection products by enabling them to be formed with a higher initial strength to permit improved handling and packaging with fewer broken and chipped tablets. In the first part of the process, sucrose is ground to a suitable size for processing in the screw-fed mixer. Simultaneously, a corn syrup solution is prepared for mixing with the sucrose in the mixer. Both the ground sucrose and the corn syrup solution are then fed to the screw-fed mixer. After achieving uniform blending of the ingredients, the moist mixture is dropped at to conveyor which brings it to a sieve, which breaks up lumps prior to feeding to a vibratory bed drier in the preferred form. From the drier, the material is passed to a screen separator where the particle size range for the product is finalized. Correctly sized product is recovered and mixed with flavor to be pressed into a candy.

### BACKGROUND OF THE INVENTION

The invention relates to a method that provides a dry granular sugar ingredient, which improves the production of compressed, tableted confection products by enabling them to be formed with a higher initial strength to permit improved handling and packaging with fewer broken and chipped tablets.

Confections are made in a wide variety of forms, and one of long-standing popularity is comprised principally of sugar and flavoring compressed into tablet form. The tablets can be flavored with, for example, various types of mint, such as peppermint, spearmint, wintergreen and the like, or can be fruit or spice flavored, such as orange or cinnamon. A sampling of tablets available commercially, as they have been for many years, reveals that all too often the tablets are split or broken and sometimes have surface or other portions broken off. Thus, despite the fact that the technology for making the compressed tablets has been developed for many years, the basic products are still subject to failure for reasons of ingredient nonuniformity, product handling prior to packaging and the rigors of commercial shipping and handling.

In a traditional process for forming candy tablets, a granular candy formulation is deposited volumetrically in a punch press and is compressed therein. The press can have one or two movable punches, with best results usually calling for the use of opposed punches. The granular candy formulation must be free flowing so that it is well adapted for filling the punch, yet must permit strong bonding upon the application of pressure. Following compression, the candy tablets are conveyed to a packaging area where they are wrapped singly or in groups. Some are wrapped in hermetically sealed round stacks, as the familiar Lifesavers® candy products, and some are packed in tins or bags. In all cases, it is very important for the candy to have a high degree of integrity and strength both initially and over time.

The principal ingredient for compressed candies, such as mints, is sucrose, in a dry, granular, free-flowing form, typically preprocessed in some manner to make it more adaptable to processing. The formulation will also contain some other sugars, such as invert sugar, fructose, corn syrup, dextrins, and the like, in addition to the flavoring and coloring ingredients necessary for the particular candy product. In some cases it is desirable to add a binder to enable bonding and in others moistening will be sufficient.

There are several methods for achieving granulation suitable for compression. Among these are wet granulation, fluidized bed granulation, slugging and other methods. In virtually all of the granulation techniques, the moisture content of the formulation will be adjusted to under 3%, e.g., between about 0.75 and 2.0%. Each product will, however, have an optimum, which will depend on the formulation and the product characteristics desired. In general, an increase in the moisture content of the formulation the tablets will cause them to be initially softer and require time to harden. Their green strength will be less. On the other hand, as the moisture content is decreased, the tablets will tend to have a lower end strength after storage in addition to causing more difficulties in pressing into well defined tablets without chipping or breaking.

In U.S. Pat. No. 3,365,331, to Miller, et al., a dry, free-flowing sucrose product is prepared by heating to concentrate a concentrated sucrose solution and subjecting the resulting supersaturated sugar syrup to a heat dissipation operation simultaneously with vigorous agitation by impact beating. The method produces a dry sugar product comprising aggregates of fondant-size sucrose crystals. The feed syrup has a purity in the range of 85-97% by weight sucrose, with invert sugar (equal portions of glucose and fructose) in an amount of up to about 15%.

In U.S. Pat. No. 4,362,757, Chen, et al., describe another method for preparing a dry, granular, free-flowing crystallized sugar product containing invert sugar or other ingredient. The product is described as composed of agglomerates or aggregates of minute, fondant-size sucrose crystals or particles intimately associated with the active ingredient. They describe a two-stage process. In the first stage, a premix is prepared by mixing a dry granular or transformed sugar base with a heat-sensitive, acidic, or high invert sugar substance. In the second or cocrystallization stage, a sugar syrup is concentrated to about 95-98% by weight solids by heating at a temperature in the range from about 255° to 300° F., mixing the concentrated sugar syrup with a predetermined amount of the premix, subjecting the new mixture to impact beating within a crystallization zone until a crystallized sugar product made up of aggregates of fondant-size sucrose crystals and the heat-sensitive, acidic, or high invert sugar substance is formed, the crystallized sugar product having a moisture content of less than 2.5% by weight, and recovering the crystallized sugar product from the crystallization zone. If desired, the resulting crystallized sugar product may be dried to a moisture content of less than 1% by weight, followed by screening to a uniform size.

Other processes for preparing a compressible granular sugar composition involve blending corn syrup with sucrose, declumping and drying. In wet granulation, sugar in granular form is screened to a uniform particle size and mixed with a granulating solution until a firm dough is formed. The granulating solution containing water, and sometimes an added binder, will cause the particles to stick together in the form of agglomerated granules. The added binders are often selected from among gum arabic, gelatin, starches and alginates. The level of addition is selected by the skilled worker for the product form intended. The mixing may take a significant period of time, sometimes up to about one hour or more, and yields a dough that is roughly milled and dried at moderate temperature for up to 24 hours, or so. Other drying methods can also be employed, such as fluidized beds, rotary driers, microwave, and the like. The principal feature of this type of processing is the formation of a wet dough prior to drying. It can be costly, time-consuming and labor intensive. And, importantly, it does not provide uniformly consistent results.

Other process have been suggested (see, for example, Jackson, Sugar Confectionery Manufacture, 2^{nd} Edition, 1999, pp. 236-258). In a process involving the use of a fluidized bed, a bed of powder is fluidized in an air stream and sprayed with binder solution. This produces powder agglomerates in the form of granules, which are subsequently dried in the air stream in the fluidized bed.

The state of the art is such that product uniformity and product strength are often less than desired and often result in high processing costs, frequent cleaning and other process shut downs and unacceptably high numbers of broken or damaged product pieces.

There remains a need for a method that would improve the production of a granular sugar ingredient for compressed confections having improved strength.

### BRIEF DESCRIPTION OF THE DRAWING

The invention will be better understood and its advantages will become more apparent from the following description, especially when read in light of the accompanying drawing, wherein:

FIG. 1 is a schematic flow diagram for a preferred process arrangement of the invention.

FIG. 2 is a graph showing particle size distribution for a representative granular sugar component prepared according to the process of the invention.

### SUMMARY OF THE INVENTION

It is an object of the invention to provide a method for simplifying the preparation of a free-flowing, granular sugar component suitable for use in preparing compressed confections such as pressed mints.

It is an object of the invention to provide a method for simplifying the preparation of compressed confections such as pressed mints.

It is yet another object of the invention to provide a method for preparing compressed confections having improved strength.

It is yet another object of the invention to provide a method for preparing compressed confections having uniform strength at lower compression pressures.

It is yet another object of the invention to provide a method for preparing compressed confections having improved green strength without the need for adding binders or increasing compression pressure.

It is yet another object of the invention to provide a method for preparing compressed confections having improved strength and/or uniformity without increasing the pressing pressure required.

It is yet another object of the invention to provide a method for preparing compressed confections having improved strength and/or uniformity in a simplified process, which requires minimal intervention or process down time.

These and other objects are accomplished by the invention, which provides improvements in processing a granular sugar ingredient for use in compressed confections having improved strength. The products of these processes are also improved.

The process for preparing the granular sugar component of the invention comprises: feeding granulated sucrose and a solution of corn syrup to a screw-fed mixer wherein they are mixed to provide a uniform wet mixture of the sucrose coated with the corn syrup; discharging the wet mixture to a sieve means to break up lumps; preferably feeding the wet mixture to a drier to further reduce the moisture content to a predetermined lower moisture content; feeding a dry mixture to a screen separator where excess fines and oversize particles, if any, are separated; and recovering correctly sized product.

The process for preparing the compressed confection of the invention comprises:
(a) preparing a granulated sugar ingredient by feeding granulated sucrose and a solution of corn syrup to a screw-fed mixer wherein they are mixed to provide a uniform wet mixture of the sucrose coated with the corn syrup; discharging the wet mixture to a sieve means to break up lumps; preferably feeding the wet mixture to a drier to reduce the moisture content to a predetermined lower moisture content; feeding a dry mixture to a screen separator where excess fines and oversize particles, if any, are separated; and recovering correctly sized product; (b) mixing the granulated sugar ingredient with flavor; and (c) compressing the granulated sugar ingredient and flavor to form a compressed candy.

The process has a number of preferred aspects, many of which are described below and shown in the accompanying drawings.

### DETAILED DESCRIPTION OF THE INVENTION

The invention enables improving the initial strength of pressed tablet confections by the use of a particular manner of processing sucrose and corn syrup to provide a granulated sugar material. Pressed confection tablets are commonly referred to as “pressed mints” because of the flavor usually associated with such products. However, since the flavorant of a pressed mint need not be mint, the term “pressed tablets” is adopted throughout this description as a term meant to include tablets made by compressing a granulated sugar material with mint and other flavors.

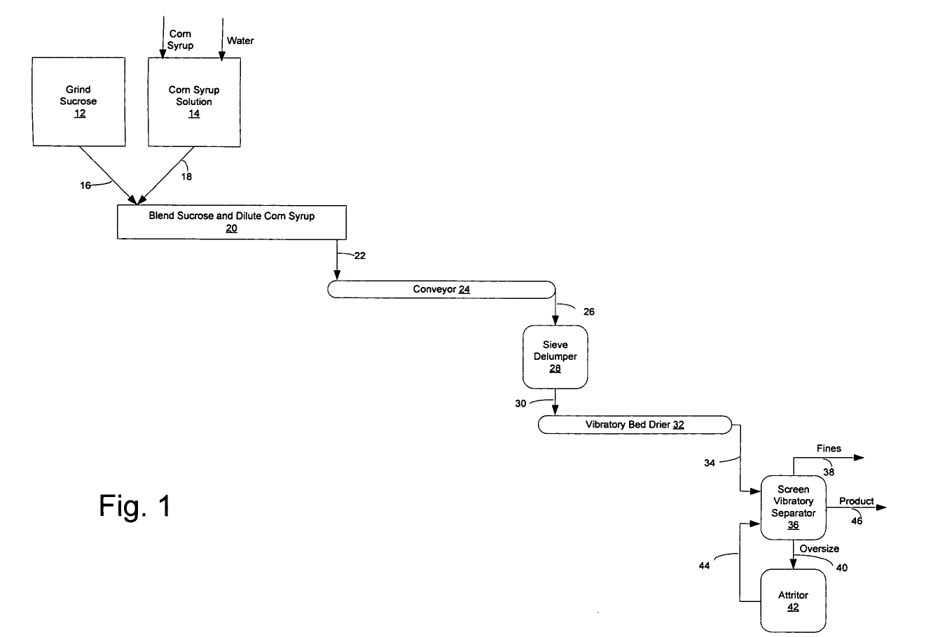

Reference is made to FIG. 1, which FIG. 1 is a schematic flow diagram for a preferred process arrangement of the invention. In the first part of the process, sucrose is received from the supplier and ground 12 to a suitable size for processing in the screw-fed mixer 20 utilized according to the invention. Simultaneously, a corn syrup solution 14 is prepared for mixing with the sucrose in the mixer 20. Both the ground sucrose and the corn syrup solution are then fed (lines 16 and 18) to the screw-fed mixer 20. After achieving uniform blending of the ingredients, the moist mixture is dropped at 22 to conveyor 24, which brings it at 26 to a sieve 28, which breaks up lumps prior to drying. Preferably, it is fed at 30 to a vibratory bed drier 32. From the drier the material is passed at 34 to a screen separator 36 where fines are optionally separated at line 38, oversize particles are separated at line 40, reduced in size in an attritor 42 and passed back to the screen separator 36 via line 44. Correctly sized product is recovered via line 46.

At the start of the process, the sucrose will be ground to a suitable size to assure adequate mixing and wetting by the corn syrup solution, without the production of fines, which can cause hydration anomalies. Preferably, the sucrose will be ground to a particle size typical of confections sugar (10× to 4×), preferably of about 6×. The sucrose will preferably be supplied as sucrose alone, but can be preblended with minor ingredients, if desired, to the extent that they will not either be damaged by the heating and agitation or otherwise interfere with processing for the free-flowing granular sugar ingredient of the invention.

The corn syrup will be of a suitable DE to effectively form the free-flowing granular sugar ingredient of the invention. Typically, the DE will desirably be a standard grade, e.g., 42 DE, and will be of commercial concentration of solids, e.g., about 42° Baumé. The water will be sufficient to decrease the solids content of the corn syrup solution to from about 55 to about 75%, e.g., about 59 to 64%, solids. The water is preferably warmed to a degree sufficient to enhance mixing without inefficiently using energy.

The ground sucrose and corn syrup solution are then fed (lines 16 and 18) to the screw-fed mixer 20, preferably of the twin screw type, such as described for the preparation of cookie dough in U.S. Pat. No. 4,938,127, to van Lengerich, but in addition to mastication sections, includes sections for back mixing in the feed section and chopping at the outflow. The back mixing is provided by including one or more flights on the screws that cause forward pressure while permitting back flow. In this manner, the available water in the corn syrup solution is caused to the extent possible to uniformly coat the sucrose particles before it is permitted to dissolve the sucrose. In the case of the preferred type of twin screw mixer 20, e.g., a Werner & Pfleiderer ZSK extruder, the screw speed can be selected as needed. The exact speed level will be largely within the operators discretion and the limits of the equipment, with a preferred range being from about 20 to about 130 rpm, e.g., 30 to 50 rpm.

The barrel of the mixer is preferably heated sufficiently to facilitate mixing and uniform coating of all particles with liquid, but not so hot as to cause pressure or mixing problems. Typically, it has been found that the product should be heated sufficiently to raise the temperature of the mix to from about 130° F. to about 210° F. at the exit, e.g., more narrowly from 140° F. to about 175° F. Temperatures will vary with formulations and equipment and deviations of up to about 35° F. from the stated values are seen as practical.

The moisture content of the mixture of ingredients will preferably be within the range of from greater than 1 to less than 6% throughout the mixer 20. The initial moisture of the ingredients fed to mixer 20 will be greater than at the discharge end, typically varying from about 2.0 to 6.0, more narrowly, from about 2.3 to about 2.5%, at the feed end to up to 6%, more narrowly from about 1.9 to about 2.1, at the discharge end. This amount of moisture is found to provide a product that meets the objectives of the invention while being insufficient to fully dissolve all sugar, an essential feature of the prior art processes relying on cocrystallization.

After achieving uniform blending of the ingredients in the mixer 20, the moist mixture is dropped at 22 to conveyor 24, which brings the still moist blend of sucrose and corn syrup solution is fed at 26 to a sieve 28, which deduces the size of lumps prior to feeding at 30 to a vibratory bed drier 32. This step takes the large lumps of sucrose and corn syrup solution and breaks them into smaller aggregates having a granular appearance and of a size suitable for drying and final classification for use in preparing pressed tablets. Representative, but preferred, as a sieve unit is a Fitzpatrick FitzMill size reduction comminutor, which includes a screen element to facilitate size reduction and regulation of particle (aggregate) size range. Effective, preferred particle sizes range from about 4 to about 200 mesh at this stage in the process. The mixture is still moist at this point in the processing, typically in the range of from about 1 to 3%, more narrowly from about 1.4 to about 1.7%, and size reduction is not final here. It is an advantage of the invention that mixing in this manner provides a great improvement in product quality even when the preferred finishing steps are not done as is optimum. The material at this point possesses processing advantages and can be stored after this processing stage if suitably dry, e.g., near the lower end of the preferred range.

The material from the sieve 28, is dried at 32, preferably in a drier of the fluidized bed type. A preferred form of drier is a Witte vibratory bed fluidized bed drier, which reduces the moisture to the extent desired for final product formation. The moisture out of the drier will preferably final and be at a level effective for forming compressed tablets. Typically, the moisture at this stage will be under 1.5%, and more narrowly will be within the range of from about 0.4 to about 1.2%, preferably less than 1%, e.g., toward the lower end of the range. From the drier 32 the material is passed at 34 to a screen separator 36 where fines are optionally separated, if present at too high a concentration, at line 38, oversize particles are separated at line 40, reduced in size in an attritor 42 and passed back to the screen separator 36 via line 44. Typically, and preferred for the separator 36 is a Sweco® vibratory separator.

Correctly sized product is recovered via line 46. The product will preferably have a bulk density of from about 600 to about 800 grams per liter. It is an advantage of the invention that uniform particle size distribution can be achieved, typically having the following values as set out in the Table that follows immediately. The process of the invention provides a narrow, relatively high particle size distribution, which has a number of additional advantages, including flow consistency, product uniformity, reduced pressure requirement or increased hardness at the same pressure, reduced fines and lower required processing temperatures. The particles referred to here are granules, which are in fact agglomerates of primary sucrose particles having essentially the same size as the sucrose starting material, being held together by a matrix of corn syrup solids.

| Sieve | | % Variation | Range, | Range, |
|---|---|---|---|---|
| Number | Standard % | from Standard | Minimum % | Maximum % |
| 6 | 0 | 5.0 | 0 | 5.0 |
| 8 | 0 | 5.0 | 0 | 5.0 |
| 10 | 5 | 5.0 | 0 | 5.0 |
| 20 | 15 | 10.0 | 5 | 25.0 |
| 40 | 40 | 20.0 | 20 | 60.0 |
| 60 | 20 | 10.0 | 10 | 30.0 |
| 80 | 5 | 5.0 | 0 | 10.0 |
| 100 | 5 | 5.0 | 5 | 5.0 |
| 200 | 5 | 5.0 | 0 | 10.0 |
| Pan | 5 | 0 | 0 | 5.0 |

Following the recovery of the granular sugar ingredient of the invention, it can be employed to produce pressed candy tablets. The following is a table presenting preferred ranges for the principal ingredients in a pressed candy product according to the invention. The formulation for a pressed mint with mint flavor can contain up to about 4% stearic acid (or alternatively other lubricants, such as calcium stearate or magnesium stearate) or other compression aid and up to about 15% flavor and color, depending on the flavor source, the flavor intensity and the color desired.

The ingredients from the following Table are blended, as in a suitable blender, such as a ribbon blender or a paddle blender operated at sufficient speed to assure uniform blending of the stearic acid or other lubricant and flavor and/or other minor ingredients. Once mixed the granular sugar ingredient of the invention is stored until needed and then filled into press chambers and compressed at a pressure suitable for preparing pressed tablets, typically at pressures of from about 2,000 to about 8,000 psi, more narrowly from about 3,000 to about 6,000 psi. To a degree, the pressure will depend on the speed of the press, with lower pressures being effective for lower press speeds and higher pressures being desired as the press speed increases. A preferred product has components at near the midpoints of the ranges in the table below, which lists representative candy ingredient levels.

| Ingredient | Weight % |
|---|---|
| Sucrose | 90-96 |
| Corn Syrup | 3 to 8 |
| Water | 0.4 to 1.2 |
| Stearic Acid | 0.1 to 1.0 |
| Mint Oil Flavor | 0.1 to 1.5 |

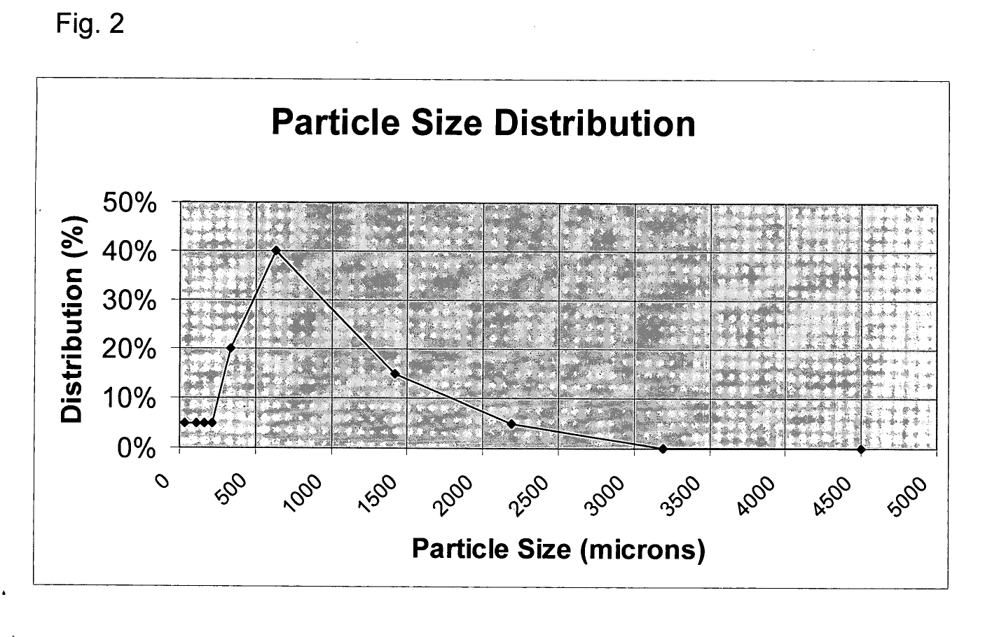

A graph showing particle size distribution for a representative granular sugar component prepared according to the process of the invention is presented in FIG. 2. The data for the product represented in the graph is given in the following table. Preferably, from 40 to 80% of the particles in the final product will pass through a 10 mesh screen and be retained on a 60 mesh screen. This particle size distribution of granules formed by the process of the invention utilizing a twin screw mixer is found to provide a range of advantages and benefits as discussed above. The advantages are highly reproducible, making production of compressed confection tablets more efficient and reliable than achievable by the prior art procedures.

| SIEVE | | |
|---|---|---|
| | Average | Std. Distribution |

| Mesh | Microns | Microns | % | Cum % |
|---|---|---|---|---|
| 6 | 4000 | 4500 | 0% | 100% |
| 8 | 2380 | 3190 | 0% | 100% |
| 10 | 2000 | 2190 | 5% | 100% |
| 20 | 840 | 1420 | 15% | 95% |
| 40 | 420 | 630 | 40% | 80% |
| 60 | 250 | 335 | 20% | 40% |
| 80 | 180 | 215 | 5% | 20% |
| 100 | 150 | 165 | 5% | 15% |
| 200 | 75 | 113 | 5% | 10% |
| pan | 0 | 38 | 5% | 5% |
| | | | 100% | |

One preferred product form is a ring-shaped candy with a diameter of about 0.9 inches, a thickness of about 0.25 inches and a center hole of about 0.25 inches in diameter, with rounded top and bottom surfaces, compressed to a weight that yields pieces meeting the following weight targets for five pieces: from a minimum of about 15 grams to a maximum of about 22 grams, more narrowly from a minimum of 17.7 grams to a maximum of 18.8 grams.

The above description is intended to enable the person skilled in the art to practice the invention. In is not intended to detail all of the possible modifications and variations which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement of sequence which is effective to meet the objectives intended for the invention, unless the context specifically indicates the contrary.

1. A process for preparation of a free-flowing granular sugar ingredient suitable for forming compressed confections, comprising:
feeding granulated sucrose and a solution of corn syrup to a screw-fed mixer wherein they are mixed to provide a uniform wet mixture of the sucrose coated with the corn syrup, wherein the corn syrup is employed in an amount within the range of from about 3 to 8% by weight, the solids content of the corn syrup solution is from about 55 to about 75% and the sucrose is employed in an amount within the range of from about 90 to 96% by weight;
discharging the wet mixture to a sieve means to break up lumps; and
recovering granules of sucrose bound together by corn syrup solids.

2. A process according to claim 1, the moisture is at a level to a level of less than about 3% by weight upon discharge from the mixer, and the moisture is reduced to a final level of less than about 1%.

3. A process according to claim 1, wherein the sucrose has a grind size of about 6× or finer and the corn syrup solids content of the corn syrup solution is from about 59 to about 64% upon entering the mixer.

4. A process according to claim 1, wherein from 40 to 80% of the granules in the final product will pass through a 10 mesh screen and be retained on a 60 mesh screen.

5. A process for preparation of a free-flowing granular sugar ingredient suitable for forming compressed confections, comprising:
feeding granulated sucrose and a solution of corn syrup to a screw-fed mixer wherein they are mixed to provide a uniform wet mixture of the sucrose coated with the corn syrup;
discharging the wet mixture to a sieve means to break up lumps;
feeding the wet mixture to a drier to reduce the moisture to a predetermined lower moisture content;
feeding a resulting dry mixture exiting the drier to a screen separator where excess fines and oversize particles are separated; and
recovering correctly sized granules of sucrose bound together by corn syrup solids.

6. A process according to claim 5, wherein the corn syrup is employed in an amount within the range of from about 3 to 8% by weight, the solids content of the corn syrup solution is from about 55 to about 75% and the sucrose is employed in an amount within the range of from about 90 to 96% by weight.

7. A process according to claim 5, wherein the moisture is less than about 5% by weight upon discharge from the mixer.

8. A process according to claim 5, wherein the moisture is reduced to a level of less than about 3% by weight by the drier.

9. A process according to claim 5, wherein the sucrose has a grind size of about 6× or finer and the corn syrup solids content of the corn syrup solution is from about 59 to about 64% upon entering the mixer.

10. A process according to claim 5, wherein the sucrose has a grind size of about 6× or finer, the solids content of the corn syrup solution is from about 59 to about 64% upon entering the mixer, the corn syrup is employed in an amount within the range of from about 3 to 8% by weight, the sucrose is employed in an amount within the range of from about 90 to 96% by weight, the moisture is at a level to a level of less than about 5% by weight upon discharge from the mixer, and the moisture is reduced to a level of less than about 3% by weight in a fluidized bed drier.

11. A process for preparation of a compressed confection, comprising:
(a) preparing a granulated sugar ingredient by
feeding granulated sucrose and a solution of corn syrup to a screw-fed mixer wherein they are mixed to provide a uniform wet mixture of the sucrose coated with the corn syrup;
discharging the wet mixture to a sieve means to break up lumps; and
recovering granules of sucrose bound together by corn syrup solids;
(b) mixing the granulated sugar ingredient with flavor; and
(c) compressing the granulated sugar ingredient and flavor to form a compressed candy.

12. A process according to claim 11, wherein the sucrose has a grind size of about 6× or finer, the corn syrup solids content of the corn syrup solution is from about 59 to about 64% upon entering the mixer, the corn syrup is employed in an amount within the range of from about 3 to 8% by weight, and the sucrose is employed in an amount within the range of from about 90 to 96% by weight.

13. A process according to claim 11, wherein the moisture is at a level of less than about 5% by weight upon discharge from the mixer.

14. A process according to claim 11, which further includes the steps of:
feeding the wet mixture to a fluidized bed drier to reduce the moisture content to a predetermined lower moisture content.

15. A process according to claim 14, which further includes the step of:
feeding a resulting dry mixture exiting the drier to a screen separator where excess fines and oversize particles are separated.

16. A process according to claim 15, wherein the solids content of the corn syrup solution is from about 55 to about 75%.

17. A process according to claim 11, wherein from 40 to 80% of the granules in the final product will pass through a 10 mesh screen and be retained on a 60 mesh screen.

18. A process according to claim 17, wherein the corn syrup is employed in an amount within the range of from about 3 to 8% by weight, the sucrose is employed in an amount within the range of from about 90 to 96% by weight and the moisture is at a level of less than about 5% by weight upon discharge from the mixer and the process includes the further steps:
feeding the wet mixture to a fluidized bed drier to reduce the moisture content to a predetermined lower moisture content; and,
feeding a resulting dry mixture exiting the drier to a screen separator where excess fines and oversize particles are separated.

19. A product prepared according to the process of claim 1.

20. A product prepared according to the process of claim 11.
